(19) United States
(12) Patent Application Publication
(10) Pub. No.: US 2009/0028765 A1
(43) Pub. Date: Jan. 29, 2009

(54) PROCESS TO PRODUCE MOLYBDENUM COMPOUNDS, FROM SPENT MOLYBDENUM CATALYZERS, INDUSTRIAL RESIDUES AND METAL ALLOYS

(76) Inventor: Samuel Aguirre Diaz, Campinas (BR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/956,939

(22) Filed: Dec. 14, 2007

(30) Foreign Application Priority Data
Jul. 25, 2007 (BR) PI0703015-0

(51) Int. Cl. C01G 39/00

(52) U.S. Cl. 423/58

(57) ABSTRACT

A process for producing molybdenum compounds, from spent molybdenum catalyzers, industrial residues and metal alloys, particularly an integrated process for reclaiming molybdenum, vanadium, nickel, cobalt, aluminum and other metals, starting with the treatment of exhausted catalyzers, industrial residues and metal alloys, principally from petroleum de-sulfurization catalyzers; the molybdenum trioxide is obtained by precipitation of ammonium octamolybdate and its calcination. Starting from molybdenum trioxide, other compounds derived from molybdenum can be obtained, as sodium molybdate, molybdenum disulfite and ammonium molybdate.

### RELATED APPLICATION

The present application claims priority to Brazilian Application No. PI0703015-0 filed Jul. 25, 2007, which is incorporated herein in its entirety by reference.

### BACKGROUND OF THE INVENTION

The present invention is in a field related to processes for the production of Molybdenum Compounds.

### DESCRIPTION OF THE PRIOR ART

Molybdenum is a typical transition metal, with broad application in the steel industry in the form of alloys and in agriculture, as an important micronutrient for several crops.

One half of the molybdenum supply comes from processing molybdenite, powelite and wolfranite. The other half comes with a sub-product of copper casting. Besides other industrial uses, molybdenum is used in catalysis. The largest use of molybdenum, is to desulphurize petroleum, petrochemicals and coal derived products, where the emission of sulfur dioxide is minimized.

Several patents and scientific papers have proposed routes to permit the use of the metals contained in these catalyzers. U.S. Pat. No. 4,087,510 comments the alkaline lixiviation stage of the catalyzer. Particularly in this patent, the procedures of the alkaline extraction of molybdenum and vanadium are described, using sodium carbonate at a temperature of 650° Celsius, in a rotating furnace or fluidized bed. Molybdenum extraction under the conditions of the '510 patent is over 95%. However, none of the previous patents describe methods to extract molybdenum in industrial scale. The patent developed a system using counter-current concept, in order to achieve high extraction rates. U.S. Pat. No. 4,587,109 describes methods for the purification of phosphorus and vanadium (main contaminants). In the method used in the patent mentioned, phosphorus is precipitated as a double ammonia and magnesium salt; vanadium is separated from the sodium molybdate solution in the form of ammonium metavanadate. The level of vanadium obtained in the molybdenum trioxide is of about 500 ppm. If lesser vanadium concentrations are desired in the molybdenum trioxide, one can utilize the resources presented in U.S. Pat. No. 4,468,373. In this patent, vanadium is recovered from molybdenum, by extracting with a solvent (tricaprylmethylammonium chloride). The vanadium separated by solvent can be recuperated. After the elimination, the vanadium contained in the sodium molybdate solution must be precipitated for final purification. This is done by adding nitric acid to adjust the pH (2.5-3.0), causing the precipitation of ammonium octamolybdate.

Octamolybdate precipitation is described in U.S. Pat. Nos. 4,587,109 and 4,273,745. It is also important to mention the methods to obtain alumina, nickel and cobalt. The cake obtained after alkaline lixiviation had practically all its molybdenum and vanadium extracted, but almost all aluminum, nickel and cobalt are present in the lixiviated cake and should be reclaimed. A method is described to recuperate aluminum, nickel and cobalt in U.S. Pat. No. 3,773,890. In this patent, the cake obtained after alkaline lixiviation undergoes a reaction with caustic soda at 250° Celsius (25 bar). Ninety six percent of the aluminum is extracted as sodium aluminate in solution. The remaining residue is basically composed of nickel and cobalt and can be used in the manufacture of metal alloys. This method was tested and confirmed by the inventor, but this process involves a large number of unitary operations. With this in mind, a direct method was developed, which consists in a direct reduction with coal of the cake obtained after alkaline lixiviation, the molten alumina, nickel and cobalt being separately obtained for metal alloys. This process is described in detail in U.S. Pat. No. 5,702,500.

### SUMMARY OF THE INVENTION

The present invention describes an integrated process to use molybdenum, vanadium, nickel, cobalt, aluminum and other metals, starting with the treatment of spent catalyzers, industrial residues and metal alloys, mainly from catalyzers used to desulphurize petroleum. Molybdenum trioxide is obtained by precipitation of ammonium octamolybdate and its calcination. Molybdenum trioxide is a source to obtain other molybdenum compounds, as sodium molybdate, molybdenum disulfide, and ammonium molybdate.

The present invention describes an integrated and economically feasible process, particularly to recuperate metals contained in molybdenum catalyzers (specially catalyzers of de-sulfurization), industrial residues and metal alloys. The present invention stands out for not generating solid residues, as the liquid effluent is easily treated by biological means (nitrate and ammonia). The exhausted catalyzer is mixed with alkaline materials (sodium carbonate, sodium nitrite, caustic soda) and calcined at 600-850° Celsius for about 2 hours (residence time). The solution arising from the lixiviation is basically made up of sodium molybdate, sodium vanadate, phosphates, sulfates, chlorides and aluminum extracted in the solution. Vanadium and phosphorus are precipitated by the addition of ammonia nitrate and magnesium nitrate. If desired, the vanadium can be obtained separately by an extraction with solvent at pH 7, with tricaprylmethylammonium chloride. After this purification, the sodium molybdate solution is precipitated in the form of ammonium octamolybdate. The octamolybdate is washed to eliminate the chlorides and sulfates and it is later calcined, to obtain pure molybdenum trioxide. From the molybdenum trioxide, one can prepare sodium molybdate, adequate for all agricultural and industrial applications. The effluent of this process, basically constituted by ammonia and nitrates, can be treated by biological means, natural and inexpensive. Alumina, nickel and cobalt are obtained by a reduction with coal at 2200° Celsius, from the alkaline lixiviation cake. Alumina is obtained in the form of a molten alumina, while nickel and cobalt are recuperated in the form of a metal alloy.

### BRIEF DESCRIPTION OF THE DRAWINGS

FIG. 1 is a flowchart of the best mode of the process for producing molybdenum compounds, from spent molybdenum catalyzers, industrial residues and metal alloys of the present invention.

FIG. 2 is a flowchart of the route for the recovery of Aluminum, Nickel and Cobalt from the lixiviated cake, using pressure (25 bar) in order to extract Aluminum.

FIG. 3 is a flowchart of another route for the recovery of Aluminum, Nickel and Cobalt from the lixiviated cake, using high temperature (2000° Celsius) in order to extract Aluminum, Nickel and Cobalt.

FIG. 4 is a flowchart of the alternative route to extract molybdenum and vanadium by solvents.

### DETAILED DESCRIPTION OF THE INVENTION

The present invention particularly describes an integrated process to recovery molybdenum, vanadium, nickel, cobalt, aluminum and other metals, from the treatment of spent catalyzers, industrial residues and metal alloys, mainly from catalyzers of petroleum de-sulfurization. Nickel and cobalt will be used in the form of an alloy; vanadium can be reused, starting as an alloy with iron or from vanadium pentoxide; molybdenum will be reused as sodium molybdate or molybdenum trioxide; eventually, aluminum will be recovered as molten alumina. The invention here described in this patent, was not only tested in the laboratory, but also in industrial scale.

### Alkaline Lixiviation

The catalyzer used in the plant was previously calcined. The catalyzer is milled in a ball mill till reaching 0-5% retention in the 100 mesh sieve and 40% in the 200 mesh sieve. This grain structure is ideal to reach a high speed reaction and also not being so fine as to clog the press filter.

Initially, the catalyzer was submitted to a reaction with 50% caustic soda (3500 kg of catalyzer, 600 liters of 50% soda, 10 m³ of industrial H₂O) but even with this high soda/catalyzer rate, and also performing the reaction in several steps, it is very difficult to go over 88% yield in the extraction of molybdenum. Aiming to increase the yield of molybdenum extraction an industrial test was performed. The test consisted in a calcination of the catalyzer with sodium carbonate, keeping it at 650° Celsius, with a residence time at this temperature of 2 hours. After this calcination, the catalyzer was submitted to a lixiviation with industrial H₂O at 80° Celsius (2-3 ton H₂O/1 ton of catalyzer). Afterward, the catalyzer was filtered in a press filter, and washed with industrial H₂O. The yield in this extraction was 95%. It is possible to extract molybdenum from metal alloys using sodium carbonate at 850° Celsius in a calcination furnace, with a residence time of 3 hours.

To design an industrial installation, the ideal would be to perform lixiviation with industrial H₂O, in three countercurrent stages (catalyzer enters in the first stage, industrial water enters in the third); there are three super-decanters which perform the separation of liquid/solids continuously. The super-decanters tested meet all the requirements of the process. In this manner mentioned, extraction of the molybdenum goes to over 98%. The sodium carbonate/catalyzer rate is situated in the range of 0.2 ton-0.7 ton of carbonate per ton of catalyzer. One should keep in mind that high carbonate/catalyzer ratio acts in favor of molybdenum extraction, but increases the aluminum dragging in the lixiviated solution.

As to the catalyzer calcination system with carbonate, it was mixed with the alkali, with the help of a ribbon-blender. The mixture was fed into a rotating furnace where it was calcined. The same test performed with sodium carbonate was repeated with sodium nitrite and caustic soda (50%) obtaining similar results.

TABLE 1
Composition of the catalyzers before, and after lixiviation (dry basis).

| | | CATALYZER |
|---|---|---|
| ELEMENTS | CATALYZER USED (%) | LIXIVIATED (%) |
| Mo | 10.5 | 0.3 |
| Ni | 2 | 3.1 |
| Al | 44 | 46 |
| Co | 0.6 | 1.1 |
| Zn | 0.34 | 0.61 |
| V | 0.3 | 0.07 |
| P2O5 | 1.2 | 0.4 |
| Si | 3.7 | 3.25 |
| Humidity | 0.2 | 38 |

TABLE 2
Composition of the lixiviated solution.

| | CATALYZER | |
|---|---|---|
| ELEMENTS | USED (%) | SOLUTION LIXIVIATED (%) |
| Mo | 10.5 | 2.1 |
| Ni | 2 | 0.0005(5 ppm) |
| Al | 44 | 0.5 |
| Co | 0.6 | 0.0042(42 ppm) |
| Zn | 0.34 | 0.02(200 ppm) |
| V | 0.3 | 0.06 |
| P2O5 | 1.2 | 0.6 |
| Si | 3.7 | 0.35 |

### Recovery of the Aluminum, Nickel and Cobalt From the Lixiviated Cake

There are two routes which allow the recovery of the Aluminum, Nickel and Cobalt from the lixiviated cake. The first route consists in submitting the lixiviation cake to a reaction with caustic soda a 250° Celsius at a pressure of 25 bar. In this condition, the aluminum is extracted in the form of a sodium aluminate solution (Na₂AlO₂). The nickel and cobalt remain in the cake, and will be used to make alloys. The sodium aluminate reacts with an acid to precipitate aluminum hydroxide. In fact, this route involves a series of unitary operations, as washing the nickel and cobalt, after the precipitation of the aluminum hydroxide. Besides this, when the hydroxide is formed, there is a formation of a solution with an inorganic salt (should sulfuric acid be used to neutralize the aluminate, sodium sulfate is formed in the solution). This process is described in U.S. Pat. No. 3,773,890.

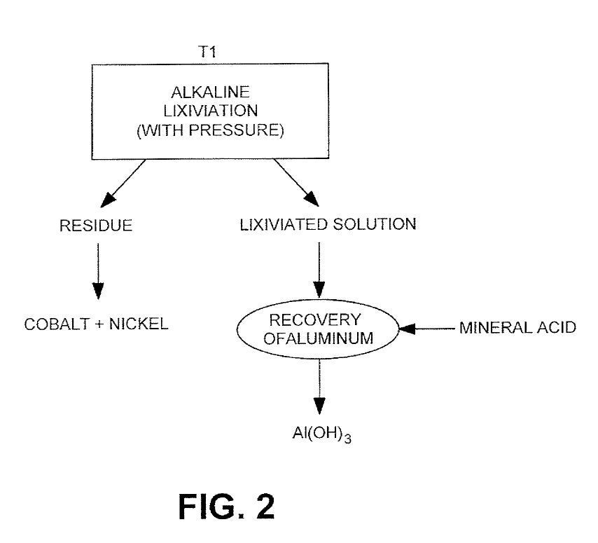

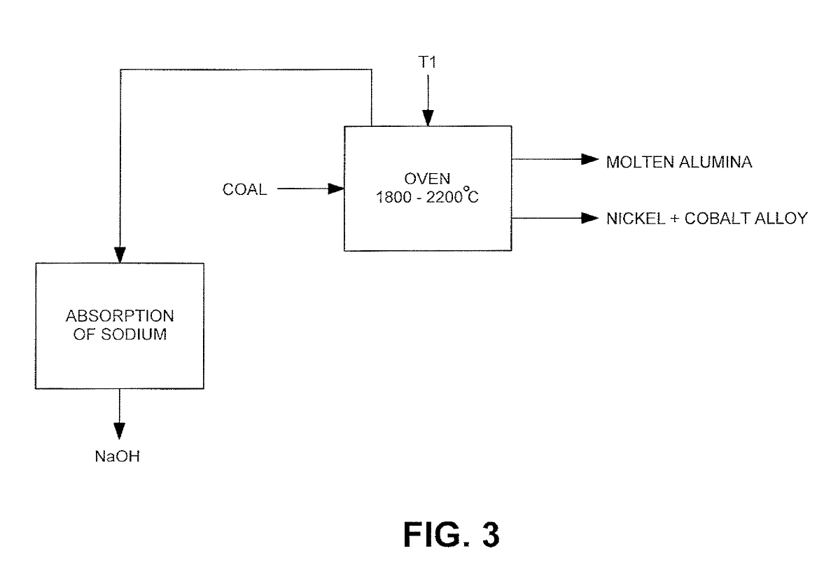

The second route which seems the most appropriate for our process consists first in drying the cake after lixiviation, reducing its humidity of 40% to values below 1%. Afterward, coal will be added to reduce all the oxides to the metal form. The amount of coal added should be from 10% to 30% over of the stoichiometric amount required. The mixture of lixiviated cake and coal is fed into an electric arc type oven, at a temperature in the range of 1800-2200° Celsius. In the furnace, two molten phases will be formed. The upper phase will contain the pure alumina, and in the lower phase, nickel and cobalt. The excess sodium in the alumina will be vaporized by the high temperature and later on will be washed in a scrubber system, for its later reuse. FIGS. 2 and 3 present the two routes discussed in this topic in a schematic form. The U.S. Pat. No. 5,702,500 discusses in depth the second route mentioned above.

There is still a third route, which consists in reacting the lixiviated cake with HCl at 100° Celsius into the azeotropic composition of the acid. Even though this route extracts 94%, filtering the cake, after the acid attack, is extremely difficult. Another inconvenience is the amount of effluent generated in this process (1 kg of cake generates 10 kg of effluent).

### Concentration of the Lixiviated Solution

A solution of sodium molybdate, obtained in the alkaline lixiviation of the molybdenum catalyzer should be concentrated to 2.1 (see Table 2), till reaching a concentration of 7%. This concentration should be made for two reasons: (a) in the treatment to remove vanadium and phosphorus the solution should be around 7% of molybdenum, to maximize the precipitation of the ammonium metavanadate and, double magnesium and ammonium phosphate; and (b) in the precipitation of the ammonium octamolybdate the solution should be around 7%, to maximize the precipitation of the molybdenum salt.

The concentration operation of the molybdenum solution could be made by a multiple effect evaporator, for example, a triple effect evaporator. In a triple effect evaporator, rates of 1 ton steam/2.5 tons evaporated H₂O can be reached.

### Removal of the Phosphorus and Vanadium

Phosphorus and vanadium are the main contaminants in the concentrated solution of sodium molybdate (7% molybdenum). Precipitation of the vanadium will be made due to the addition of ammonia ions to the solution. The vehicle to add these ions of ammonia is ammonia nitrate. Ammonia nitrate is added to maintain the concentration of ammonia ions, of the order of 3 to 4 NH₃ moles per molybdenum mol, which, in our case, means 1200-1400 kg of NH₄NO₃, for each 7 m³ of solution (7% of molybdenum). This range will maximize the precipitation of vanadium, besides supplying the necessary amount of ammonium ions for an adequate precipitation of the ammonium octamolybdate. Vanadium will be precipitated in the form of ammonia metavanadate (NH₄VO₃).

Precipitation of the phosphorus occurs due to the addition of magnesium nitrate. The phosphorus will precipitate in the form of double salt (NH₄MgPO₄). The amount of magnesium nitrate added varied from 20 kg to 200 kg for each 7 m³ of solution (7% of molybdenum). Greater additions of magnesium facilitate the removal of the phosphorus in the solution; however, the more magnesium is added the worse becomes the precipitation of vanadium. For each case, laboratory tests should be made before from the addition of any recipe at an industrial scale. The pH of adding these salts has fundamental importance in the efficiency of removing vanadium and phosphorus from the solution of sodium molybdate. The pH of the ideal solution to add these salts should be in the range of 11 to 11.5. After adding these salts, the pH of the solution should be in the range of 8 to 9. The concomitant addition improves both the precipitation of the phosphorus, as for vanadium.

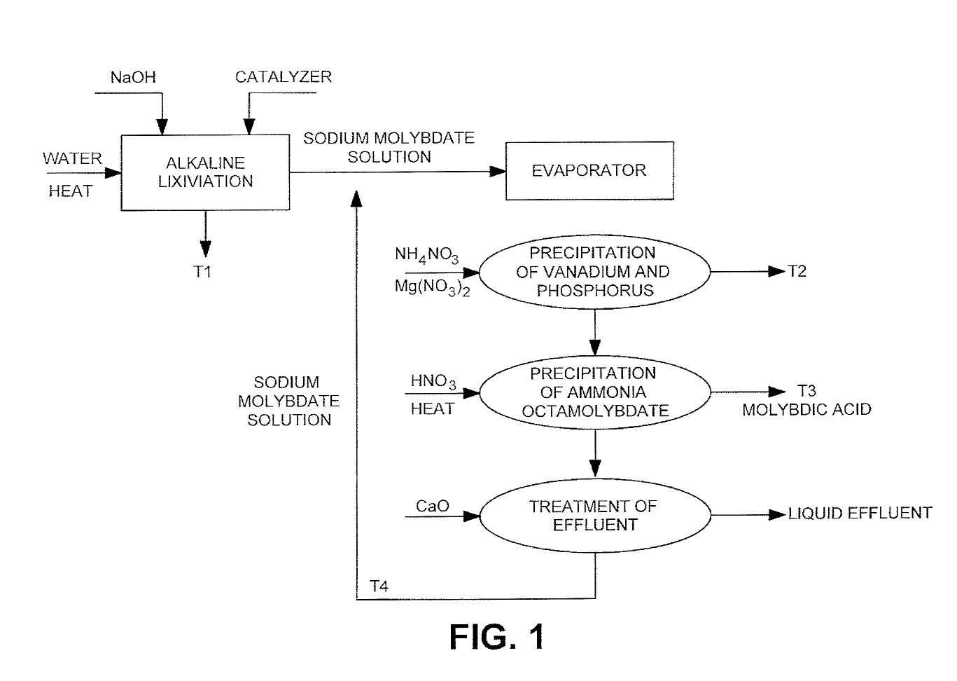

Filtration of the solution (7% of molybdenum) can be made at once in a plate type press filter. The Table below presents the analytical results found in precipitation of this type. It is important to mention that for every ton of octamolybdate produced, 400 kg of cake is generated (cake T2—see FIG. 1). Table 3 below presents the analytical results of cake T2 (dry basis).

| ELEMENTS | Cake T2 (%) |
|---|---|
| V2O5 | 21 |
| P2O5 | 22.5 |
| Al2O3 | 45 |
| MgO | 16.8 |
| Na2O | 4.8 |
| SO4 | 1.8 |
| SiO2 | 1.1 |
| CaO | 0.35 |
| MnO | 1.0 |
| MoO3 | 1.5 |

### Removing Vanadium By Extraction With Solvent

Analyzing the composition in Table 3, it is evident that the disposal of vanadium can be a problem. Besides this, vanadium has commercial value and could be used, if it were precipitated, before the formation of cake T2. With this in mind, vanadium was separated from the lixiviated solution of molybdate (7% molybdenum), using an ammonium quaternary named tricaprylmethylammonium chloride.

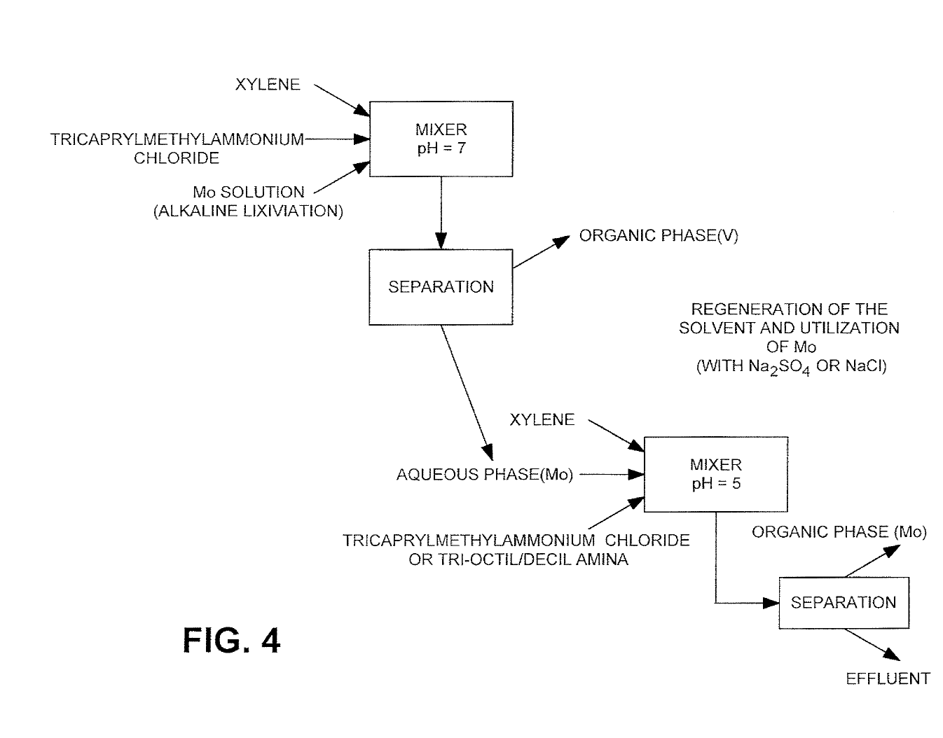

Tricaprylmethylammonium chloride, diluted in xylene, was capable to selectively extract vanadium, when the molybdate solution pH was adjusted to 7 tricaprylmethylammonium chloride was regenerated using a solution of Na₂SO₄ (see FIG. 4). Vanadium was recuperated in the form of sodium vanadate. The efficiency of this method, which is described in U.S. Pat. No. 4,468,373, was checked. Still according to this patent, molybdenum can be selectively extracted adjusting the pH of the solution to 5. Molybdenum was recuperated in the form of sodium molybdate, and tricaprylmethylammonium chloride was regenerated using a solution of sodium sulfate. There are references which indicate that to remove molybdenum, tri-octil/decil amina could be used.

One could think of using this method to concentrate the solution of sodium molybdate, via extraction with solvent, skipping the evaporator concentration stage and the phosphorus and vanadium precipitation stage. However, the octamolybdate obtained with this method is of inferior quality to that obtained. Besides this, as a solution arising from the alkaline solution of the catalyzer contains much more molybdenum, than vanadium, it would be necessary to use much more tricaprylmethylammonium chloride (or tri-octil/decil amina), to remove the molybdenum. Another complication to concentrate the molybdenum, via solvent, is that it would be another stage of regeneration of the ammonium quaternary and consequently one more handling of xylene.

After all that was discussed in the previous paragraph, what is needed is to effectuate the vanadium extraction via extraction by solvent. Afterwards, a solution of sodium molybdate, without vanadium, would be submitted to the treatment described in item 2.3.4. This stage is of fundamental importance, for in it, the precipitation, of various cations and anions occurs. Vanadium extraction by solvent would be located between stages 2.3.3 and 2.3.4.

Precipitation of the vanadium obtained could have been done in various ways, as taught in U.S. Pat. No. 3,510,273.

### Precipitation of Ammonia Octamolybdate

After the purification, which happened in phase 2.3.4, the ammonia molybdate solution has a pH between 8 and 9. Due to the addition of ammonia nitrate, the ratio NH₃/Mo will be superior than 3. In this manner, lowering the pH (to 2.5-3.0), by adding nitric acid, precipitation of the ammonia octamolybdate occurs ((NH₄)4Mo₈O₂₆). In order to accelerate this reaction, it should be heated to a temperature of 80° Celsius (for 3 hours). After precipitation, the octamolybdate cake should be washed with hot H₂O (80° Celsius). This procedure eliminates sulfates, chlorides and vanadium. Table 4 below shows a typical analysis of octamolybdate cake. If there are vanadium ions in the solution, they can be reduced to valence +4, so that, when precipitation of the octamolybdate occurs they will remain in solution.

| ELEMENTS | Cake T3 (%) |
|---|---|
| Mo | 32 |
| P2O5 | n.d |
| Al2O3 | 0.001(10 ppm) |
| MgO | 0.002(200 ppm) |
| V | 0.035(350 ppm) |
| SO4 | n.d |
| SiO2 | 0.001(10 ppm) |
| Cl | 0.3 |
| NO3 | 5 |

### Production of Molybdenum Trioxide and Sodium Molybdate

In the present invention it is designed a calcination unit for ammonium octamolybdate, to produce molybdenum trioxide. This unit, in its first part, consists in a dryer unit (expanded bed dryer), whose objective, is to dry the octamolybdate cake (from 35% to values less than 3% humidity). Afterwards, a small disintegrating mill can be used, which feeds a fluidized bed. The fluidized bed operates at 450° Celsius, with a residence time of 2 hours. There is still an ammonia absorption unit, which is liberated during the calcination stage. The trioxide produced in this manner has high purity, for its content goes over 64% of molybdenum.

Sodium molybdate can be produced using the classical route, by a reaction with soda and trioxide. There is the possibility of producing sodium molybdate starting from a reaction of the octamolybdate with caustic soda. Both methods will produce good quality sodium molybdate, apt for all applications in industry and agriculture.

### Treatment of the Effluent

For each 1.5 tons of octamolybdate produced about 7 m³ of effluent are produced, with a composition shown in Table 5, below.

| ELEMENTS | EFFLUENT (%) |
|---|---|
| Mo | 0.1 |
| V | 0.02 |
| Cl | 0.11 |
| SO4 | 0.24 |
| Mg | 0.1 |
| NH3 | 1.2 |
| NO3 | 0.5 |
| PH | 2.7 |

The pH is adjusted with lime (CaO), to pH 8, and the system left in agitation for 3 hours. Afterwards, 300 liters of aluminum polychloride are added (for each 25 m³ of effluent) and the system is left in agitation for another 2 hours. The effluent is then filtered; in this stage the molybdenum and vanadium are removed from the liquid effluent. The cake from the filtration (T4) is recycled to the alkaline calcination furnace (see FIG. 1) for the reuse of the molybdenum. The liquid effluent, without molybdenum and vanadium, is sent to biological treatment, with the intention to consume nitrate and ammonia from the effluent.

There is still an optional method to remove the molybdenum and V from the effluent. The technique consists in using tricaprylmethylammonium chloride, at a pH of 2.5, to remove the molybdenum and vanadium. Tricaprylmethylammonium chloride, under these conditions, can be regenerated with caustic soda. Molybdenum and vanadium obtained in this manner are recycled to stage 2.3.4. One can remove the vanadium and molybdenum from the solution by adsorption in an active carbon column.

Having thus described the invention, what is claimed as new and secured by Letters Patent is:

1. A process for producing molybdenum compounds, from spent molybdenum catalyzers, industrial residues and metal alloys, the process comprising the steps of:
(a) lixiviating an exhausted catalyzer with an alkaline material selected from the group consisting of: sodium carbonate, sodium nitrite and caustic soda; the alkaline material added at a rate ranging from 0.2 to 0.7 tons of an alkaline material/ton of catalyzer, at a temperature ranging from 550° to 950° Celsius for a period of time ranging from 2 to 3 hours, producing a lixiviated solution;
(b) calcinating the lixiviated solution at a temperature ranging from 600° to 850° Celsius for a period of time of about 2 hours; obtaining a lixiviated solution cake substantially constituted of sodium molybdate, sodium vanadate, phosphates, sulfates, chlorides and aluminum, and a lixiviated cake;
(c) reducing humidity of the lixiviation cake from about 40% to about 1%;
(d) recovering aluminum, nickel and cobalt from the lixiviated cake by reduction with coal at a rate ranging from 10% to 30% over the stoichiometric amount required, at a temperature ranging from 1800°-2200° Celsius for two hours; or by reacting the lixiviated cake with HCl at a rate ranging from 18% to 33% at a temperature of about 100° Celsius for one hour, wherein the aluminum is recovered in the form of molten alumina and the nickel and cobalt are recovered in the form of a metal alloy;
(e) concentrating the lixiviated solution to a concentration of ranging from 1.5% to 10% in a multiple effect evaporator;
(f) precipitating phosphorus from the concentrated lixiviated solution by adding from 20 kg to 200 kg of magnesium nitrate for each 7 m³ of solution, wherein the magnesium nitrate is added to the solution with the pH in the range of from 11 to 11.5 lowering the pH of the solution to a range of from 8 to 9, producing phosphorus precipitated in the form of a double salt;
(g) precipitating vanadium from the concentrated lixiviated solution by adding ammonia nitrate, at a rate ranging from 3 to 4 moles of the ammonia ions per mol of molybdenum, and magnesium nitrate; or by extracting with tricaprylmethylammonium chloride at a concentration ranging from 0.1-20%, diluted in xylene, at a pH in the range of from 6 to 8; obtaining ammonia metavanadate;
(h) precipitating the sodium molybdate from the concentrated lixiviated solution by adding ammonia nitrate at a ratio ammonia/molybdenum ranging from 3-4 molar ratio, at a pH of ranging from 0 to 4 by adding an acid selected from the group consisting of: hydrochloric acid, nitric acid, and sulphuric acid; at a temperature of about 80° Celsius for a period of time of about 3 hours; or by extracting with tricaprylmethylammonium chloride or tri-octil/decil amina ranging from 0.1-20%, diluted in xylene, at a pH in the range of from 3.5 to 6.5; obtaining ammonia metavanadate; obtaining ammonium octamolybdate cake;
(i) washing the ammonia octamolybdate cake with hot water at about 80° Celsius, eliminating sulfates, chlorides and vanadium;
(j) reducing humidity of the ammonia octamolybdate cake from about 35% to about 5%;
(k) calcinating the washed ammonia octamolybdate cake on a fluidized bed at a temperature of about 450° Celsius for a period of time of about 2 hours, obtaining pure molybdenum trioxide;
(l) mixing the pure molybdenum trioxide with soda or caustic soda, obtaining sodium molybdate, adequate for all agricultural and industrial applications; and obtaining an effluent substantially constituted of ammonia and nitrates;
(m) treating the effluent by any suitable means.

2. The process according to claim 1, wherein in step (e) the multiple effect evaporator is a triple effect evaporator.

3. The process according to claim 1, wherein in step (m) the effluent is treated by any suitable biological or natural means.

4. The process according to claim 1, wherein in step (m) tricaprylmethylammonium chloride is added to the effluent at a pH of ranging from 0 to 4, for removing molybdenum and vanadium.

5. The process according to claim 1, wherein in step (m) calcium oxide and aluminum polychloride are added to the effluent, for removing molybdenum and vanadium.

6. The process according to claim 1, wherein in step (g) adding a reducer selected from the group consisting of: sulphur dioxide, metabisulfite, and sulfite; reducing vanadium from the lixiviated solution from V⁺⁵ to V⁺⁴.
